(19) United States
(12) Patent Application Publication
(10) Pub. No.: US 2013/0019590 A1
(43) Pub. Date: Jan. 24, 2013

(54) DYNAMICALLY ADJUSTING TUNED EXHAUST SYSTEM

(71) Applicant: David Maslar, Gambrills, MD (US)

(72) Inventor: David Maslar, Gambrills, MD (US)

(21) Appl. No.: 13/554,906

(22) Filed: Jul. 20, 2012

Related U.S. Application Data
(62) Division of application No. 11/360,517, filed on Feb. 24, 2006, now abandoned.
(60) Provisional application No. 60/683,773, filed on May 24, 2005.
(60) Provisional application No. 60/656,091, filed on Feb. 25, 2005.

(51) Int. Cl. F02B 27/00

(52) U.S. Cl. 60/312

(57) ABSTRACT

A method and apparatus, for adjusting an exhaust, having an at least one body element with a housing member having an at least one exhaust outlet. An at least one exhaust element is contained within the at least one body element with an at least one slip section and an at least one spring member. An at least one pressure regulating member extends and is slidingly held between the at least one body element and the at least one exhaust element. The pressure regulating member separates a pressure chamber section within the housing, wherein the pressure regulating member is pressed against the at least one spring member by pressures built up by exiting exhaust gasses in the pressure chamber resulting in a variation in the length of the exhaust system.

### CROSS REFERENCE TO RELATED APPLICATIONS

This application claims the priority of U.S. provisional patent applications 60/656,091, filed Feb. 25, 2005 and 60/683,773, filed May 24, 2005, and is a divisional of co-pending U.S. patent application Ser. No. 11/360,517 filed Feb. 25, 2006, which are incorporated herein by reference.

### FIELD OF THE INVENTION

The invention relates to an apparatus and system for automatically adjusting the tuned length of an exhaust system. More specifically, an exhaust system that uses variations in the speed of the engine and corresponding exhaust gasses to adjust the length of the exhaust system.

### BACKGROUND OF THE INVENTION

It is a well-established concept in engine design that an increase the performance of an internal-combustion, reciprocating engine can be achieved through various improvements in the exhaust system. One way to improve an exhaust system has been to utilize pressure variations developed within an exhaust system, typically through changing backpressure and resonance, to supplement the control of gases moving within the engine and its exhaust and thereby modify the pressure and pressure waves to improve engine performance. An exhaust system may develop some rather substantial pressures that are both positive and negative with reference to the ambient and these pressures may be effectively harnessed to accomplish more desirable movement of gases through the engine.

It has also been determined that the design considerations for an exhaust system include the operating speed of the engine. Generally, the significance of speed may be somewhat more apparent with the recognition that the exhaust system receives gas pulses, the frequency of which are directly related to the operating speed of the engine.

This is especially true of a two-stroke engine, such as a motorcycle engine or glow ignition two-stroke engine, a type typically found in hobby craft. The two-stroke engine has a single “breathing” cycle, wherein the exhausted gasses pass out of the cylinder and fresh air-gas mixture is taken into the cylinder simultaneously. Essentially, it is desirable to provide a negative pressure at the engine exhaust port during the interval when both the exhaust and intake ports are fully open, so as to more effectively draw a charge of fresh air-gas mixture into the cylinder. Subsequently, as the exhaust port closes it is desirable to provide a positive pressure to restore and maintain the fresh charge of air-gas in the cylinder and initiate compression.

Previous efforts at exhaust systems have attempted to provide such pressure variations; however, these efforts have all fallen short due to the complex design considerations. These solutions suffer from significantly increased sizes and weights, characteristics that detract from the performance gains that such solutions provide. Moreover, the vast majority of previous designs do not provide for adequate automatic adjustment of tuned length during operation. Instead, these designs rely on inaccurate mechanical and manual controls or limited automatic controls, if any at all, that cannot make adjustments during the operation of the system.

Generally, applications for exhaust systems for such engines involve a demand for high performance yet, are so varied that flexibility is required. This is particular significant as the size of the engine decreases, e.g., two cycle motorcycle engines versus glow ignition two stroke engines. As the lengths of the acceptable variations and degree of control over these variations moves from the scale of centimeters to millimeters, accurate automatic control becomes increasingly important, as does reducing size and weight. None of the existing designs has been able to provide a satisfactory combination of these important characteristics.

For example, U.S. Pat. No. 2,459,918 to Chester shows a size adaptation system, suitable for use in adapter exhaust pipe extensions to automobile exhaust or tail pipes of different sizes. The structure involves a tubular member, which is slidingly fitted to the exhaust pipe and is equipped with a spring for resisting its forward sliding movement. This design simply provides for movement of the pipe length relative to a bumper, as a means of protecting the pipe. It does not provide for adjustment, much less dynamic adjustment of the tuned length of the exhaust system. Nor does it provide for manipulation of the convergent and divergent portions of an exhaust in unison or variation in the geometry of such sections to vary either the angle of expansion or the angle of convergence in these sections.

In U.S. Pat. No. 3,703,937 to Tenney, an expansion chamber exhaust system for two-cycle engines with a valve that shifts position from a low RPM position to a high rpm position to provide a positive pressure wave in the exhaust chamber. This adjusts the volume of the chamber and the characteristics of the pressure wave to suit set RPM characteristics. However, the additional components add significant weight to the overall system and require modifications to provide a dual path exhaust chamber. Moreover, this system is overly complex, requiring switching between low and high RPM chamber flows. It is also limited in its RPM response, therefore limiting its overall performance. It also fails to change tuned length. Finally, the reference does not teach nor suggest the movement of both the header or divergent and belly or convergent sections or variation of the relative geometries to vary either the angle of expansion or the angle of convergence in these sections.

Another attempt is provided in U.S. Pat. No. 3,726,092 to Raczuk, which shows an exhaust system for a combustion engine, having an exhaust port with a cylindrical length. In the second embodiment, the cylindrical length has a generally conic convergent section coupled to it and contains a generally conic divergent section slidably received within it at one end. A spring is used to urge the internal conical divergent section along the cylindrical length toward the engine to vary the size of the exhaust. A manual actuator pushes the spring and, thereby, the internal conical divergent section down various positions in the cylindrical length toward the convergent section for different operating speeds of the engine.

Several problems arise in the operation of such a device. For instance, the operator needs to make constant adjustments to the exhaust to change its length. This can tax the ability of the operator to simultaneously change the exhaust length and control the vehicle. Moreover, there are significant problems in using this on small scale vehicles, such as hobby craft. In many instances the operator of these types of vehicles is not traveling on the vehicle and operator adjustment is thus impossible. This design also suffers from significant additional weight due to the control mechanism and cannot be accurately adjusted across a wide range of RPMs, just those for which the controller is pre-positioned. Finally, the reference does not teach nor suggest the movement of both divergent and convergent sections or variation of the relative geometries to vary either the angle of expansion or the angle of convergence in these sections, resulting in far less of a performance gain.

U.S. Pat. No. 3,969,895 to Krizman describes a power control valve attachment provided for assembly on an existing two-cycle engine exhaust system. The system increases back pressure by providing a perforated section with an end cap that is held within the exhaust pipe. The relative pressure from the engine pushes against the end cap, extending the perforated section out from the exhaust pipe. A spring prevents the system from falling out of the exhaust during operation. In this design, the tuned length of the exhaust system is not truly adjusted. Only the backpressure within the system is increased by obstruction with the end cap. Thus, performance gains are marginal and tuned length is not adjusted over a range of RPMs. Furthermore, the relative movement of both a divergent and convergent section of the exhaust or the variation of the geometry of either of these sections to adjust the angle of expansion or convergence is not considered in this design.

Similarly, U.S. Pat. No. 5,785,014 to Cornwell provides for movement of the exhaust controlled by exhaust pressure, but it does so by obstructing the flow of exhaust gases in a similar, albeit more complicated, manner as that of Krizman. This and similar patents provide for a variety of components to reduce the flow cross-section of the exhaust and increase backpressure, however, each falls short in that the reduction in the flow of the exhaust drops peak performance and reduces power at the highest RPM levels, specifically the RPM range beyond the peak power level, where exhaust pressures drop and a restriction in the flow or cross-sectional flow area is highly detrimental to performance.

In U.S. Pat. No. 4,715,472 to McKee an adjustable motorcycle muffler with a stationary ring and an adjustable ring at an exit end is provided. The adjustable ring is movable relative to the stationary ring to vary the amount of gas flow. Again, this increases the back pressure but does not provide for adjustment of the tuned length of the exhaust system, thus, performance gains are marginal and tuned length is not adjusted. Furthermore, adjustments during operation are not possible, limiting the performance gains available. Finally, the design fails to move either a belly or convergent cone or a header or divergent cone section, much less move these elements simultaneously or vary the geometry of these sections to manipulate the angle of convergence or divergence in the section. Additionally, this system fails to provide for dynamic adjustment of the exhaust system.

The U.S. Pat. No. 5,214,254 to Sheehan discloses a triple cone exhaust for controlling both flow and resonance within the exhaust. The triple cone has a tubular perforated sleeve, a tubular perforated tuning pipe with a conical end, and a reverse cone megaphone enclosure with the inlet and outlet of the exhaust on either end. The orifice size, and thereby the resonance of the system, can be adjusted by turning the sleeve. Again, the tuned length of the system is not adjusted in this solution, much less dynamically adjusted. Instead the resonance of the pressure wave within the system is adjusted by adjusting the noise level created within the exhaust. This system cannot make these adjustments dynamically, moreover, it does not adjust either the length of a divergent or the convergent cone section, nor does it vary the geometry of such sections to achieve any performance enhancement.

In U.S. Pat. No. 5,218,819 to Cruickshank provides an exhaust system with a variable volume by displacement of a baffle member in a baffle chamber. The volume of the chamber is increased by a baffle that opens and adds volume to the chamber. Although this may change the pressure wave within the system, it does not provide for adjustment of the tuned length of the system. Additionally, by simply adding volume in this fashion to manipulate the pressure wave it results in a larger overall exhaust, adding weight that detracts from performance gains. In addition, although the overall volume of the exhaust may be varied, the critical parts in developing the pressure waves, namely those elements like the convergent and divergent cones that produce pressure wave reflections, are not being efficiently manipulated. As the convergent and divergent cone sections are not manipulated and the system is utilizing a larger bore exhaust, its performance is diminished significantly.

U.S. Pat. No. 6,520,285 shows an adjustable muffler system for attachment to an engine exhaust system and method of adjusting or tuning the volume level of the sound emitted from an engine muffler. Again, this does not provide for dynamic adjustment of the tuned length of the exhaust system. Instead, it allows for the adjustment of the resonance or sound within the exhaust, which has little functional application to performance improvement. It also fails to manipulate either a divergent or convergent cone section to do this. It does not provide for variation in the expansion or convergence angles of these sections.

Thus, these prior attempts are inadequately addressing the problem of automatically adjusting the tuned length of an exhaust system to provide for increased performance across a wide range of applications and engine speeds. Consequently, a need exists for an improved, more flexible automatically adjustable tuned exhaust system that may be more uniformly used on a wide variety of small engines and which is capable of accomplishing improved operating performance at various engine speeds.

### SUMMARY OF THE INVENTION

An object of the invention is to provide a high-performance, dynamically adjusting, tuned exhaust system that is small, lightweight and easy to manufacture and engage.

An object of the invention is to provide for dynamic adjustment of the geometry of a divergent section to vary the angle of expansion within the section.

Yet another object of the invention is to provide for dynamic adjustment of the geometry of a divergent section to vary the angle of convergence within the section, alone or in combination with variations in the angle of divergence in the divergent section.

A still further object of the invention is to provide for a high performance, automatically, dynamically adjusting tuned exhaust system that varies the length of a divergent and convergent cone simultaneously relative to the speed of an engine through a controller and sensor package.

A further object of the invention is to provide an exhaust system that can be more uniformly used on small engines and is capable of accomplishing improved operating performance at various engine speeds.

The invention includes a system/apparatus and a method of operation of the system/apparatus.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations that would be apparent to those skilled in the art.

### BRIEF DESCRIPTION OF THE DRAWINGS

Embodiments of the invention are explained in greater detail by way of the drawings, where the same reference numerals refer to the same features.

FIG. 1 illustrates an exploded side view of an exemplary embodiment of the instant invention.

FIG. 2 shows a cross-sectional view of a further exemplary embodiment of the instant invention.

FIG. 3 shows a cross-sectional view of the further embodiment of FIG. 2 in operation, in an uncompressed state.

FIG. 4 shows a cross-sectional view of the further embodiment of FIG. 2 in operation, in a compressed state.

FIG. 5A shows a cross sectional view of a still further embodiment of the instant invention.

FIG. 5B shows the exemplary embodiment of FIG. 5a in a fully compressed state.

FIG. 5C shows a cross-sectional view of a still further exemplary embodiment of the instant invention.

FIG. 6A shows a cross-sectional view of an exemplary embodiment of the coupling of divergent slip sections.

FIG. 6B shows a cross-sectional view of an exemplary embodiment of the coupling of convergent slip sections.

FIG. 7 shows a cross-sectional view of yet a further exemplary embodiment of a dynamically adjusting exhaust system.

FIG. 8A shows a further embodiment of the instant invention.

FIG. 8B shows a further embodiment of the instant invention.

FIG. 9 shows still a further exemplary embodiment of the instant invention.

FIG. 10A shows a still further embodiment of the instant invention in an uncompressed state.

FIG. 10B shows the embodiment of FIG. 10A in a compressed state with a sharper average angle of expansion.

FIG. 11 shows a further embodiment of the instant invention.

FIG. 12 shows the embodiment of FIG. 11 in a compressed state.

### DETAILED DESCRIPTION OF THE INVENTION

The invention is generally described as exhaust system that automatically, dynamically changes length over a range of engine speeds. This change in “tuned length”, as often referred to in the industry, will produce maximum power output over a much wider range of engine speed than can be achieved with a static exhaust system. Put another way, the variation in the “tuned length” of the exhaust will maintain operation of the engine at or near the peak of its power curve over a wide range of engine RPMs.

The design and dimensions of the exhaust system described herein are for an exemplary preferred embodiment, specifically a displacement glow ignition two-stroke motor as commonly found in remote control cars, boats and airplanes. With the appropriate changes in geometry, the design can be applied to larger displacement two-stroke, four stroke, and glow ignition two stroke motors or spark ignition motors of any size. Applications may include, but are not limited to: off-road vehicles—including but not limited to ATV's and Snowmobiles; motorcycles, marine applications—including but not limited to jet skis and jet boats; hobby craft, including but not limited to model cars, model planes and model trains, and the like.

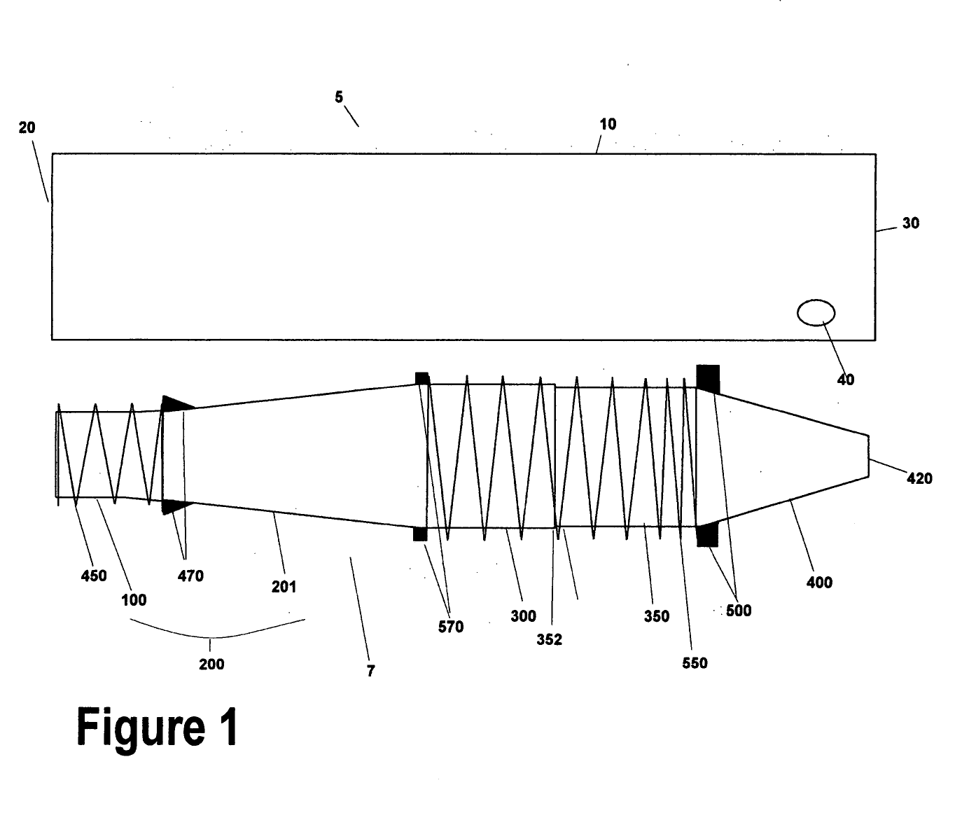

FIG. 1 illustrates an exploded side view of an exemplary embodiment of the instant invention. A body element 5 is shown with a housing member 10, made from metal or other appropriate material, provided together with an end cap 30 and a base cap 20. Body element 5 is provided with an at least one exhaust outlet 40. A single exhaust outlet is provided in the exemplary embodiment of FIG. 1; however, additional embodiments may utilize multiple exhaust outlets and these additional outlets may be spaced anywhere in the body member 5, as seen in FIGS. 1-10.

A header coupling 100 is situated at a first end of the body element 5 and couples the instant invention to a pathway for spent exhaust gas produced by the motor (not shown) and coming from the header (not shown). The header coupling 100 passes through the base cap 20 and couples to an exhaust element 7. The header coupling 100 can be attached at an end of the body element 5. The header coupling 100 can also simply pass through the body element 5. The header coupling member 100 can also be made integrally with the base cap 20 or affixed by a suitable means. In an exemplary embodiment, the header coupling 100 is screwed into the base cap 20 and affixed thereon.

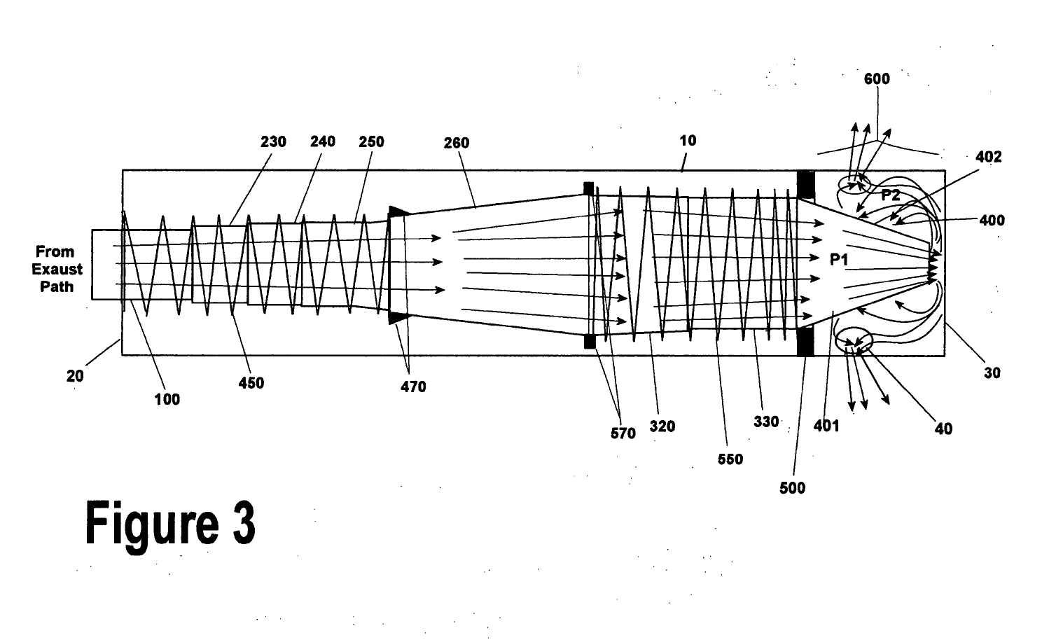

The exhaust element 7 is contained within the body element 5. An at least one slip section 200 is slidingly coupled to the header coupling 100 in the exemplary embodiment of the invention shown in FIG. 1. Additional portions of exhaust may be provided between the header coupling 100 and the at least one exhaust outlet 40 as additional portions of the at least one slip section 200, as shown in the exemplary embodiment of FIGS. 3-7. Alternate exemplary embodiments may also include static elements or sections that only act to couple the header coupling and the at least one slip section, where the at least one slip section slidingly engages these elements and/or the header coupling 100. The at least one slip section 200 may also be included as part of a belly section, a header section, a divergent conic section or convergent conic section, again, as provided in the exemplary embodiments shown. The at least one slip section 200 can be situated such that it is slidably engaged with the header coupling 100 or similar section of the exhaust pathway to permit travel and adjustment of the overall length of the exhaust system.

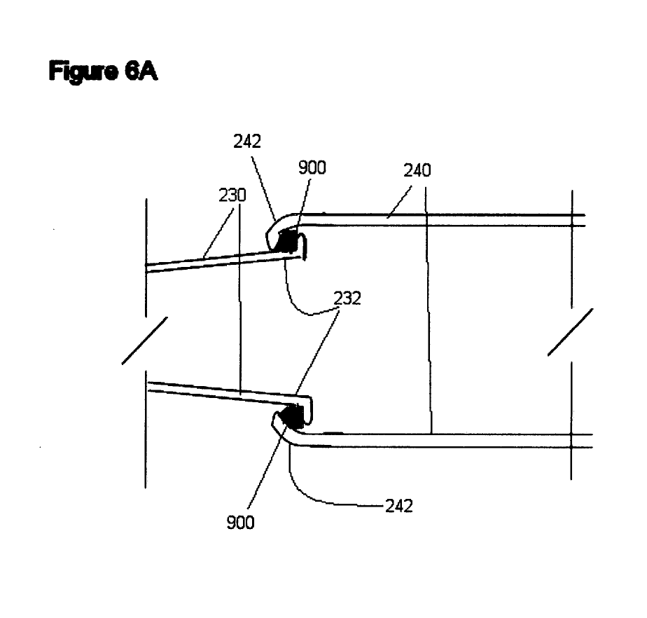

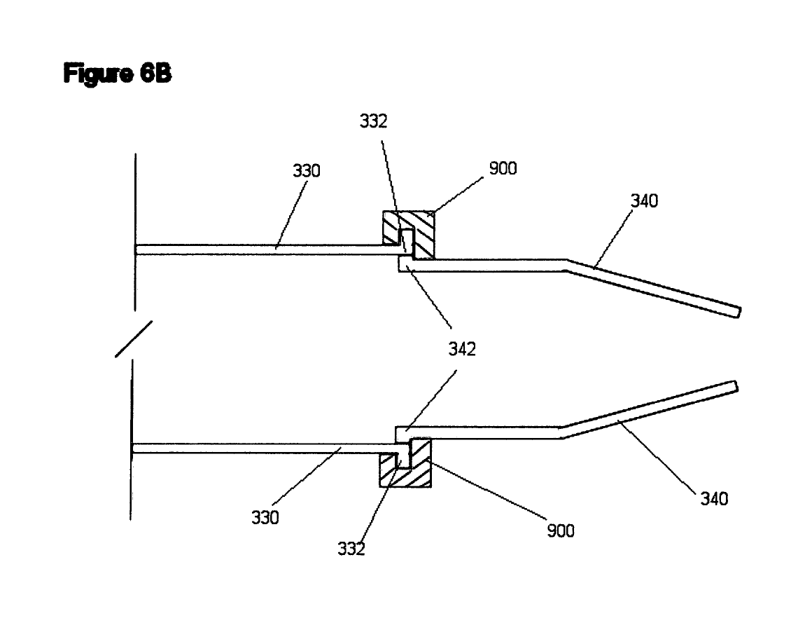

In the exemplary embodiment shown, the at least one slip section 200 is provided as a first slip section 201 that comprises a part of the header section as a divergent conic section and a second slip section 350 that comprises a part of the belly section as a convergent conic section. The header coupling 100 has a flared portion 110 that fits with a flanged portion 210 of the first slip section 201. Sealing members can also be provided as further described in relation to FIGS. 6A-6B below. In the exemplary embodiment of FIG. 1, the first slip section 201 is coupled to a body section 300. Similar to body portion 300, additional portions of exhaust may be provided between the header coupling 100 and the at least one exhaust outlet, as shown in the exemplary embodiment of FIGS. 3-10. Further exemplary embodiments may include, but are not limited to, providing additional active slip sections or static elements where these elements may adjust or may only act to couple the header coupling 100 and preceding exhaust system sections to an at least one second slip section to the at least one exhaust outlet 40. The at least one second slip section may be provided alone as parts of a header or belly section or as a portion of the divergent or convergent conic section(s) of a convergent/divergent exhaust system of the type shown in FIGS. 1-10.

In the exemplary embodiment of FIG. 1, the body section 300 is coupled to the second slip section 350 that tapers into a convergent cone section 400. The convergent cone section 400 increases the speed of the exiting exhaust gases, which flow from the exhaust end 420 into the body element 5. Between the convergent cone section 400 and the housing member 10 a pressure regulating member 500 is provided. The pressure regulating member 500 separates a pressure chamber portion 600 from the remainder of the housing member 10 when the exhaust element 7 is fit within the body element 5. The pressure regulating member 500 can be comprised of plastic, rubber, synthetic material, or similar material. As the spent exhaust gases flow out from the exhaust end 420 into the pressure chamber portion 600 and out the at least one exhaust outlet 40 it creates a net compressive force that pushes the pressure regulating member 500 toward the motor (not shown). This force equalizes and then overcomes the spring force of an at least one spring member 450.

In the exemplary embodiment shown in FIG. 1, an at least one spring member comprises a first spring member 450 and a second spring member 550. As the RPM of the motor increases, the mass flow and corresponding pressure within the pressure chamber 600 increases and the at least one spring member 450, in this case first and second spring members 450, 550 compress. The travel of the first and second spring members 450, 550 are limited by the respective spring stops 470, 570. This provides for a predictable, controlled reduction in the length of the exhaust system. The reduction is controlled by the speed in RPM of the motor and the spring force(s) of the at least one spring member, in the embodiment shown the spring rates of the first and second spring members 450,550. The RPM of the engine is directly related to rate of expulsion of the spent combustion gases and therefore the compressive forces against the pressure regulating member. The spring forces resisting this pressure force are controlled by the relative spring rate of the at least one spring member. Additional variables in controlling the adjustment of the length of the exhaust system include the ratio of the area of the exhaust end of the convergent section to the area of the at least one exhaust outlet, the placement of the at least one exhaust outlet, the inclusion of diverter members, the shape and size of diverter members, and similar variables affecting the flow of the exhaust gasses in the invention.

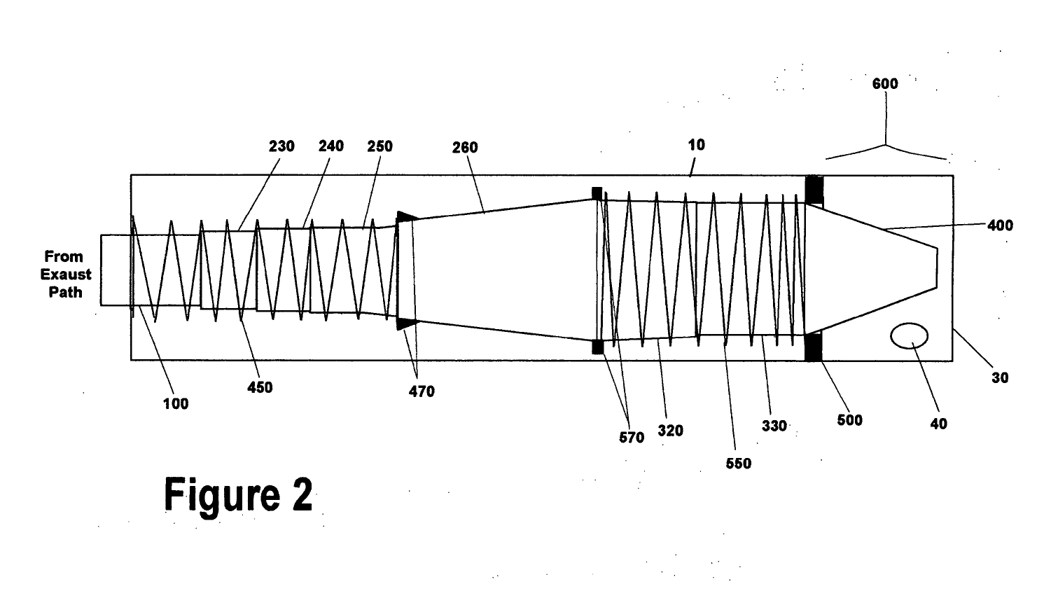

FIG. 2 shows a cross-sectional view of a further exemplary embodiment of the instant invention. The exemplary embodiment shown comprises an outer body member 5 that is essentially the same as the exemplary embodiment of FIG. 1 having a housing member 10, an end cap 30, a base cap 20 and an at least one exhaust outlet 40, in this case a first exhaust outlet and a second exhaust outlet spaced at the end of the body member 5 with the pressure chamber section 600 on opposite sides of the housing member 10.

A header coupling member 100 is affixed through the base cap 30. The header coupling member 100 may be made integrally with the base cap or affixed by a suitable means, as in the embodiment of FIG. 1. The at least one slip section is provided as a first set of slip sections 230, 240, 250, 260, and a second set of slip sections 320, 330. The sets of slip sections may be slidably affixed as in the exemplary embodiment of FIG. 1 and as further described in relation to FIGS. 6A-6B, with each of the slip sections being fitted with flanges and flared sections and sealing members to seal them against the escape of exhaust gasses. The sealing members can be rings or similarly shaped members and can for example be constructed, but is not limited to, at least one of a metal, composite, synthetic or similar material. Additional methods of slidably affixing the slip sections together may be used in conjunction with, completely or in part, with additional components. These additional components may include rings, clamps, pipe, fixtures, and similar components. The first set of slip sections 230, 240, 250, 260 and second set of slip sections 340,350, are thus slidably engaged with one another and the header coupling 100. This permits the adjustment of the at least one slip section of the exhaust. In the exemplary embodiment shown this includes slip sections that comprise at least a part of both the divergent and convergent sections of the exhaust system depicted. The multiple slip sections provide improved variation through various ranges of motor RPM.

The operation of the further exemplary embodiment of FIG. 2 is substantially similar to the operation of the exemplary embodiment of FIG. 1. The first set of slip sections 230, 240, 250, 260 are surrounded by an at least one spring member, in this case a first spring member 450. The first spring member 450 is held inside the housing tube 10 between the base cap 30 and a first spring member stop 470 mounted on a slip section 260. Similarly, the second set of slip sections 320, 330 are surrounded by a second spring member 550 held between a second spring member stop 570, also mounted on slip section 260, and the pressure regulating member 500. Thus the compression forces from the net pressure force against the pressure regulating member 500 compress the second spring member 550 and this compression force is simultaneously transmitted through slip section 260 to the first spring member 450.

FIG. 3 shows a cross-sectional view of the further embodiment of FIG. 2 in operation, in an uncompressed state. This represents the starting or low RPM position of the motor. The system is attached to the exhaust header of a motor (not shown). The exhaust gases, shown as arrows, flow through the header coupling 100, the at least one slip section 200, in this instance through the first set of slip sections 230, 240, 250, 260, that comprise part of the divergent section and on through the second set of slip sections 320, 330, into the convergent section 400 and into the rear pressure chamber section 600 of outer housing member 5. The rear pressure chamber section 600 is separated from the remainder of the body member 10 by pressure regulating member 500 extending between the body member 10 and the slip section 350 and its convergent cone section 400. The pressure regulating member 500, in the exemplary embodiment, does not allow for the escape of exhaust gasses from the pressure chamber section 600 to the remainder of the body member, which remains at atmospheric pressure. The pressure regulating member 500 does, however, allow for relative movement along the length of the body member 10.

The exhaust gases will initially exert a pressure that will push the convergent cone section 400 away from the motor with a force of P1 times the internal cross sectional area of the convergent cone as the gas passes through the exhaust end of the convergent cone 400. However, if the area of the convergent cone outlet A1 is larger than the cross sectional area of the at least one exhaust outlet A2 from the rear pressure chamber section 600 of the outer body member 5 then the pressure exerted on the inside convergent cone 401 by the exhaust gas P1 and the pressure force of the redirected gasses P2 on the exterior of the convergent cone 402 within the pressure chamber will substantially equalize or P1=P2.

If the pressure in the pressure chamber section, P2, is equal to the pressure force of the gasses passing out from the convergent cone section 710, P1, then, because the cross sectional area of the exterior of the convergent cone 402 with the pressure regulating member 500 is greater then the cross sectional area of the inside of the convergent cone 401, there will exist a net force equal to the difference in these two areas times the pressure. This net force is a compressive force pushing back against the spring force of the at least spring member. The net force pushing back against the convergent cone 710 will compress the at least one spring member 450. In this instance, the at least one spring member 450 comprises a first spring member 450 and a second spring member 550 with respective spring rates. As the second spring member 550 seats on one of the divergent cone slip sections, both sets of slip sections will have equal compressive forces, allowing them to compress in a manner determined by the relative spring ratios of the respective spring member(s). This net compressive force imbalance will act to shorten the overall length, or tuned length, of the exhaust system. This compressive force imbalance will increase as the mass flow through the exhaust system increases, resulting in a change in length that is relative to the RPM of the motor.

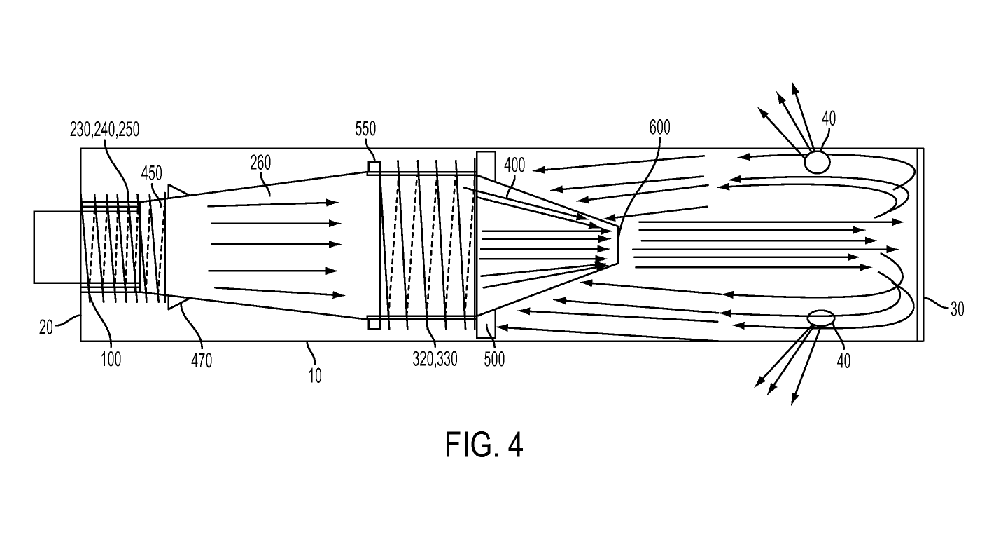

FIG. 4 shows a cross-sectional view of the further embodiment of FIG. 2 in operation, in a compressed state. As the engine RPM increases the exhaust pressure and mass flow will increase and the cones will move further toward the engine, decreasing the “tuned length” until the respective at least one spring member, in this case spring members 450 and 550, have reached the limit of movement as shown in FIG. 4. Similarly, as the RPM decreases, the net pressure force will decrease and the spring members will expand and lengthen the exhaust system. As the engine is driven through its normal operation, the RPM changes will result in similar exhaust pressure changes and the springs will push the slip sections and the attached cones to their point of equilibrium with the spring forces, automatically changing with the engine speed.

This reduction in tuned length with increased engine speed is the appropriate change for producing maximum power. By adjusting the tuned length of the exhaust system with the RPM, the appropriate tuned length for a particular RPM can be managed and the engine can work at a higher point on its power curve throughout its operating range.

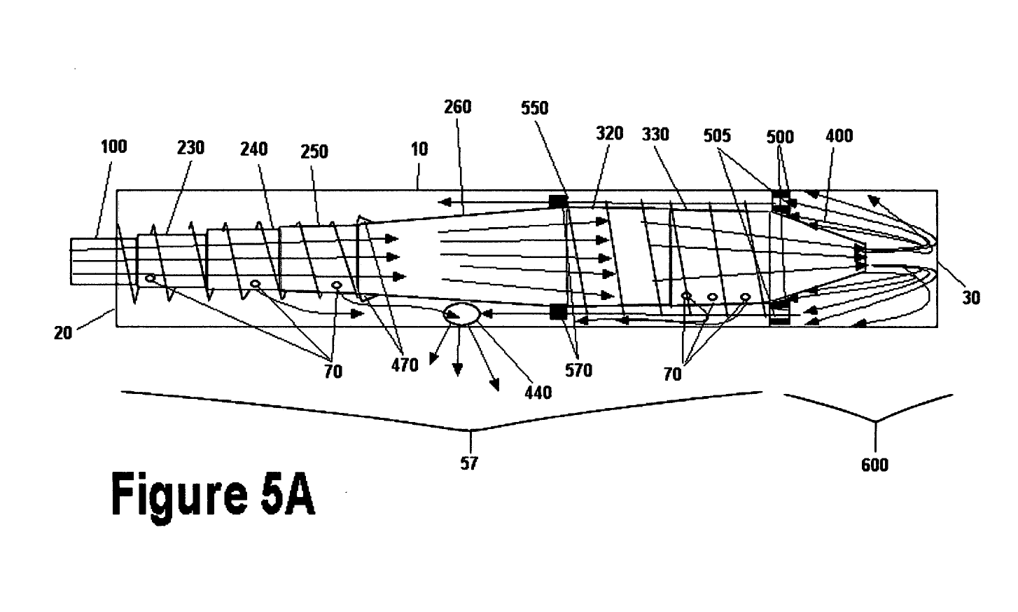

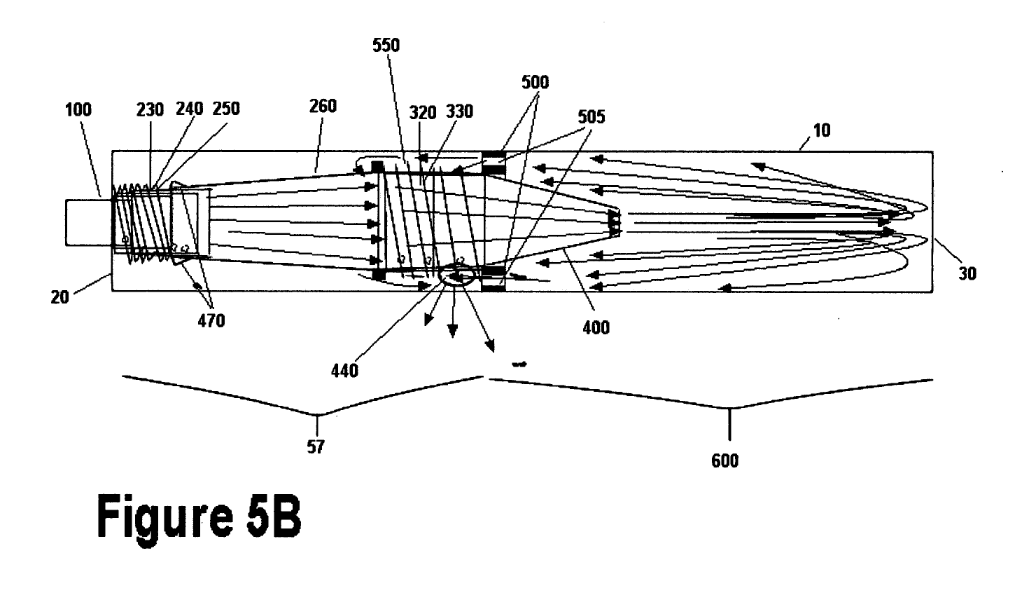

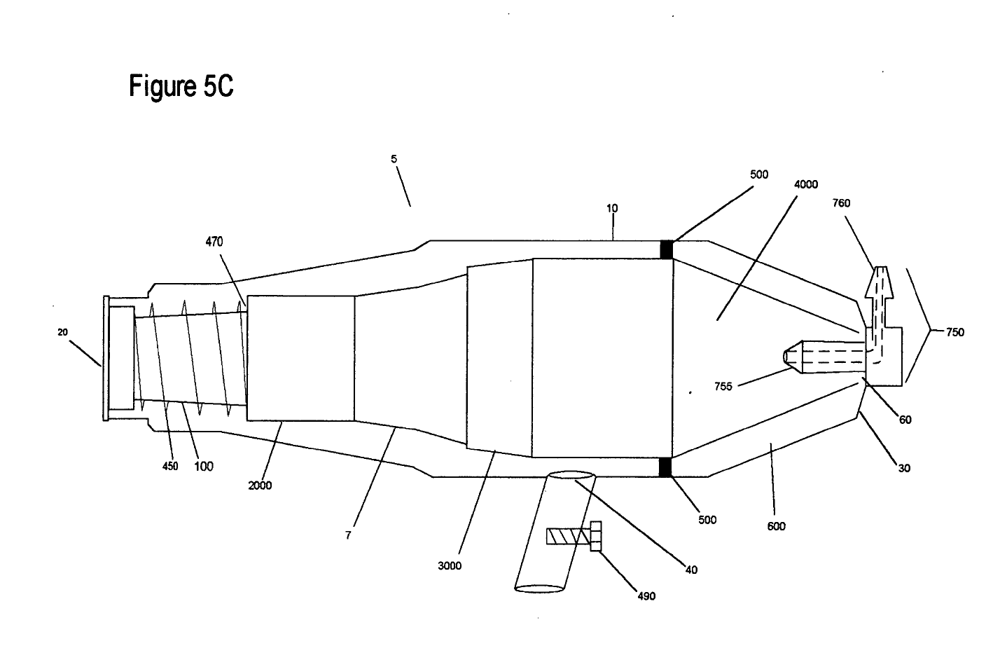

FIG. 5A shows a cross sectional view of a still further embodiment of the instant invention. This embodiment has features to accommodate conditions that may exist in certain applications. A body element 5 is shown with a housing member 10, an end cap 20, and a base cap 30. A header coupling 100 is situated at a first end of the body element 5 and couples the instant invention to a pathway for spent exhaust gas produced by the motor (not shown). An exhaust element 7 with an at least one slip section 200 is slidingly coupled to the header coupling 100. The at least one slip section 200 is provided as a first set of slip sections 230, 240, 250, 260 and a second set of slip sections 320, 330 both slidingly engaged with one another in this embodiment.

An at least one exhaust outlet 440 is located closer to the header coupling 100 on the body element 7. The at least one exhaust outlet 440, unlike previous embodiments, is located in a main body portion 57 of the housing member 10. This main exhaust outlet 440 is of sufficient size to prevent overpressure from accumulating in the main body chamber 57. Additionally, the location of the at least exhaust outlet 440 allows for any exhaust gasses or oil that may have previously accumulated in the main body chamber 57 to be expelled with the normal exhaust flow.

Between the convergent cone section 400 and the housing member 10 an at least one pressure regulating member, here shown as a single pressure regulating member 500, is provided. The pressure regulating member 500 separates the pressure chamber portion 600 from the remainder of the housing member 10 namely the main body member 57. The pressure regulating member 500, in this instance a back plate, has an at least one exhaust channel 505. The at least one exhaust channel 505, in this instance four equidistant exhaust channels, may take any of several geometries, including but not limited to holes, notches, slots, or any other applicable geometry that allows the exhaust gasses to pass through the pressure regulating member, the back plate, 500 and into the main body chamber 57. Although the at least one exhaust channels 505 allows for the exhaust to flow toward the at least one exhaust outlet 404, they restrict this flow to an extent to create a net pressure imbalance in the pressure chamber section 600 compressing the at least one spring member 450,550. Any pressure leakage from the seals of the telescoping slip sections, including the divergent cone, can be mitigated by adjusting the area of the at least one exhaust channel in the at least pressure regulating member. The at least exhaust channel 505 in the outer edge of the back plate has the added benefit of allowing any oil to pass the pressure regulating member without accumulating in the pressure chamber section 600 or the main body chamber 57.

Additionally, an at least one vent hole 70 may be added in any of the slip sections of the exhaust element. The at least one vent hole 70 can be in the at least one slip section 200, including, but not limited to, the header or divergent cone and belly or convergent cone slip sections. The at least one vent hole 70 can dynamically change the exhaust flow characteristics by allowing some of the exhaust gasses to escape prior to admission to the pressure chamber section 600, until such pressure exists so as to close a given hole by compression of the at least one slip section in which the at least one vent hole 70 is located. The existence and location of the at least one vent hole 70 will only be limited by the intention of the designer and the desired pressure and movement characteristics of the particular embodiment of the invention. The at least one vent hole 70 may also be of any other shape such as a diverging, converging, or linear slot, a hole or perforation, or other appropriate shape in order to achieve the desired movement and flow characteristics.

FIG. 5B shows the exemplary embodiment of FIG. 5A in a fully compressed state. The at least one vent hole 70 is useful since, in some instances, the normal exhaust pressure falls off at the highest rpm ranges of the motor during operation. The at least one vent hole 70 can be sized and placed, and the spring tension adjusted, such that at the peak of exhaust pressure, the movement of the at least one slip section closes a series of vent holes, forcing all of the exhaust gas through to the pressure chamber section 600 effectively trapping the slip sections in a fully compressed state as the motor moves through the highest rpm ranges. Otherwise the sections may slightly decompress in these instances as the pressure drops, even though the RPM is still increasing.

FIG. 5C shows a cross-section of yet a further exemplary embodiment of the instant invention. As depicted, this embodiment includes a body element 5 with a housing member 10, an end cap 30, a base cap 20, and an exhaust outlet 40. An exhaust element 7 resides in the housing member with a header coupling 100 that is situated at a first end with a slip section 2000 is slidingly coupled to the header coupling 100. The slip section 2000 comprises a part of the header section, and in this case part of the divergent section. The slip section 2000 is coupled to a body section 3000 that tapers into a convergent section 4000. An at least one spring member 450 is held between the base cap 20 and the respective at least one spring member stops 470. Between the convergent cone section 4000 and the housing member 10 a pressure regulating member 500 is provided that separates a pressure chamber portion 600 from the remainder of the housing member 10.

In the embodiment shown, in addition to having the slip section 2000 and pressure chamber 600, a pressure tap 750 is provided. The pressure tap 750 comprises a diverter element 755 having a vent tube 760 (shown in shadow), the pressure tap acting to partially divert some of the exhaust gasses exiting from the convergent section 4000 to pass to the ambient atmosphere through the vent tube 760. Alternatively, the exhaust gasses issuing from vent tube 760 may be utilized to provide pressure for other uses, such as, for example, providing a pressure assist in the fuel system of the motor. The diverter element 755 also partially diverts some of the exhaust gasses down and between a gap 60 extending between the convergent section 4000 and the end cap 30. The size of this gap regulates the amount of exhaust gasses diverted to the pressure chamber section 600. The amount diverted exhaust gasses increases the pressure in the pressure chamber section 600, which exerts a compressive force and shortens the length of the exhaust element in a manner similar to that described in relation to the previous embodiments. The exhaust gasses in the pressure chamber primarily exit through the exhaust outlet 40. Although the exhaust outlet 40 is pictured as a single outlet, as in other embodiments, multiple outlets of appropriate size and geometry can be utilized.

In the embodiment shown in FIG. 5C, the pressure tap 750 and diverter element 755 are provided. The geometry and size of the diverter element 755 help to regulate the pressure and compressive forces in the pressure chamber 600. As the RPM of the motor increases the pressure and mass flow into the pressure chamber section 600 shortens the length of the exhaust element 7 and the gap between the diverter element 755 and the convergent section 4000 simultaneously increases, which further increases the pressure and the compressive forces as the motor RPM rises. Additionally, an adjustment screw 490 is provided in the exemplary embodiment of FIG. 5C. The adjustment screw 490 provides for fine adjustment of the final bore size of the exhaust outlet 40. This allows for easy fine adjustment or tuning of the exhaust system to compensate for changes in ambient pressure due to weather, temperature or similar environmental conditions.

FIGS. 6A and 6B show cross-sections of exemplary embodiments of sealing members for the at least one slip sections and header coupling. In the exemplary embodiments show, TEFLON or similarly composed low friction material with the ability to survive relatively high temperature and relatively high pressure environments may be used as seals in the mating areas of the at least one slip section and the header coupling. The sealing members ease the assembly of the system, smooth the relative movement of the slip sections, improve the seating characteristics and provide for a tighter seal at the mating sections, and lower the required machining tolerances for the related components.

FIG. 6A shows a cross-sectional view of an exemplary embodiment of the coupling of divergent slip sections. A first slip section 230 is provided that is part of a divergent section. A flared section 232 of the first slip section 230 is also provided and engages a second slip section 240. The second slip section 240 includes a flanged portion 242 that slidingly fits within the flared section 232. Between the flare portion 232 and flanged portion 242 is an at least one sealing member 900. The at least one sealing member 900 is sized and shaped to fit securely between the flared and flanged portions 232,242. Alternative exemplary embodiments, such as those seen in FIG. 6B, can be located on the outside of the slip sections instead of between the slip sections. In the embodiment shown in FIG. 6A, a disk shape sealing member 900 is provided. The disk shape sealing member 900 can have be flat or have a profile to improve its fit. The second slip section 240 is urged toward the first slip section 230, sliding to adjust the length of the combined sections. The internal pressure of the exhaust keeps the sealing member 900 in place against the flanged portion 242 as the slip sections move. Thus the seal between the sections is improved.

FIG. 6B shows a cross-sectional view of an exemplary embodiment of the coupling of convergent slip sections. A first slip section 330 is provided as part of a convergent section. A flared portion 332 is provided at an end of the first slip section 330. A second slip section 340 is also provided having a flared portion 342. The flared portion 342 slidingly fits within the flanged portion 332 and is surrounded by a sealing member 900. The second slip section 340 is urged toward the first slip section 330, sliding to adjust the length of the combined sections. The sealing member 900 is retained by the flared portion 342 as the slip sections are moved relative to one another. Thus the seal between the sections is improved.

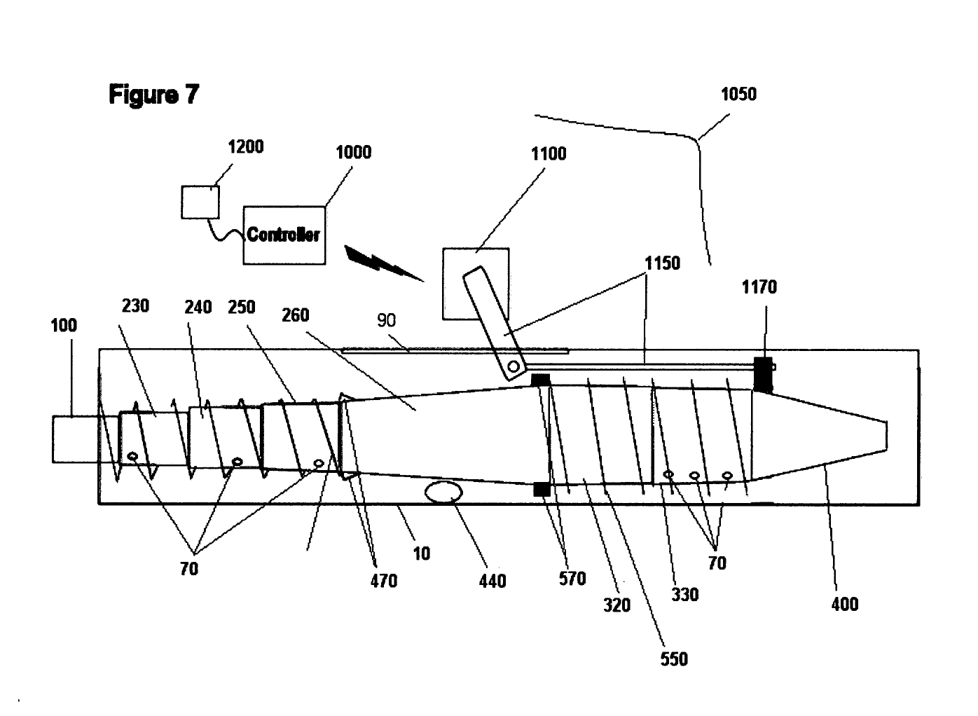

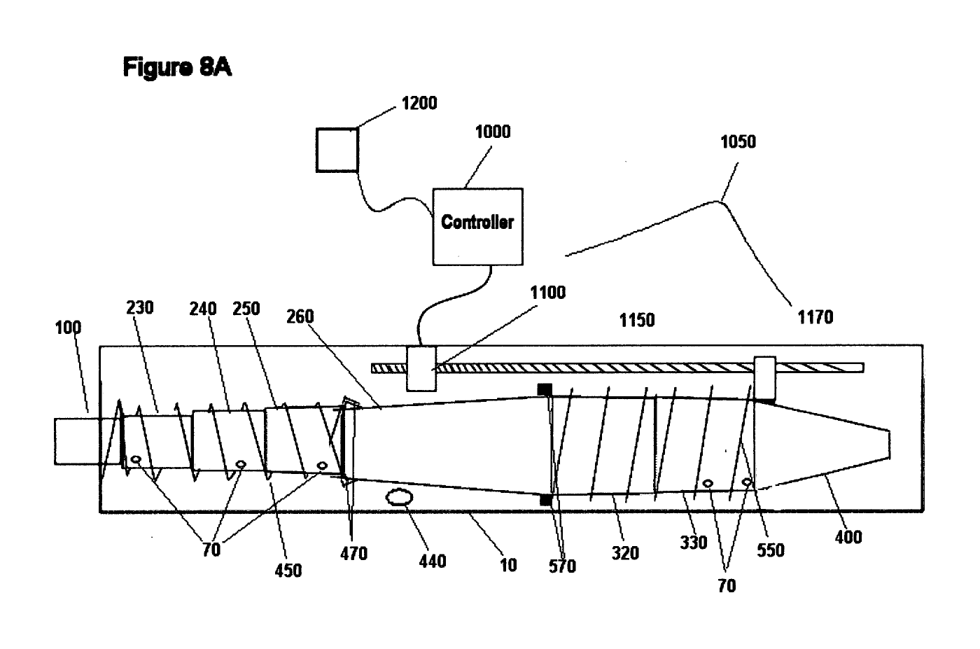

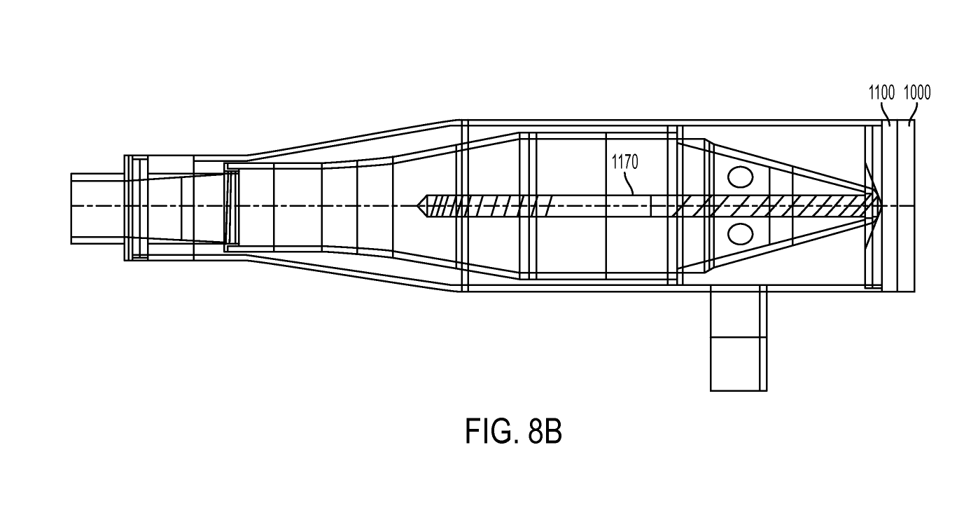

FIG. 7 shows a cross- sectional view of yet a further exemplary embodiment of a dynamically adjusting exhaust system. In the embodiment of FIG. 7, an at least one sensor 1200 is provided. The at least one sensor 1200 is located in a position to measure the motor RPM and thereby sense the speed of the motor and send a signal to the controller 1000. The at least one sensor 1200 is coupled to and communicates with the controller 1000, in this instance via a wireless connection. Alternative embodiments can utilize a standard wired coupling between the at least one sensor 1200 and the controller 1000, as seen in FIG. 8A.

The controller 1000 is then coupled to and communicates with an actuator 1100. The actuator 1100 can, for example, be but is not limited to a servo motor, a screw drive, a linear actuator, a stepper motor or similar actuating device. The actuator 1100 is part of the adjustment device 1050. An attachment device 1150 couples the actuator 1100 to a coupler 1170 coupled, in this instance, to the internal exhaust member 7 through a slot 90 in a body element 10. It should be noted that the adjustment device 1050 is not limited in anyway by the exemplary embodiments shown. The adjustment device 1050 can take any suitable form to impart motion on both the divergent and convergent conic sections simultaneously or independently. These variations being within the spirit of the invention. It should also be noted that in this exemplary embodiment, the housing member 10 is not required, but can be retained for the capture of leaking exhaust gasses and oil, or for purely cosmetic reasons.

In the exemplary embodiment of FIG. 7, the actuator 1100, acting through the attachment member 1150 and the coupler 1170, moves against an at least one spring member, in this instance a first spring member 450 and a second d spring member 550, in a manner similar to that described in the preceding embodiments, both the divergent slip sections 230, 240, 250, 260 and the convergent slip sections 330,340 are simultaneously adjusted. As the RPM of the motor changes, it is sensed by the at least one sensor 1200 and this information is conveyed to the controller 1000. Thus the controller 1000 adjusts the slip sections throughout the RPM range of the motor in response to any sensed changes. The relative length changes are calculated as a function of the compressive forces needed as related by the relative spring ratios of each of the spring members. Thus, the controller 1000 is coupled to the adjustment device 1050 in such a way that it dynamically makes the appropriate adjustments to the length of both the divergent slip sections 230, 240, 250, 260 and the convergent sections 330,340, and thereby the overall tuned length in real time relative to the RPM of the motor. The calculated compressive forces are exerted to compress the first or divergent and second or convergent sets of slip sections simultaneously to vary the overall tuned length profile of the exhaust systems relative to the RPM of the

FIG. 8A shows a further embodiment of the instant invention. In the exemplary embodiment of FIG. 8A, the at least one sensor 1200 communicates with the controller 1000 that controls the adjustment device 1050, in a manner similar to the embodiment described in FIG. 7. However, in the embodiment of FIG. 8A, the controller is coupled to the at least one sensor and the adjustment device by a hardwire connection. Further, in this instance, the actuator 1100 is a screw drive or stepper motor and the attachment member 1170 is a screw shaft that is coupled to coupling 1170. In the embodiment shown, again the controller 1000 signals the adjustment device 1050 to simultaneously adjust the first and second sets of slip sections. However, the adjustment function is not only a variation of the compressive forces through the adjustment device 1050 but also includes a variable for the changes in relative motion of the sections through the differing screw pitches on the screw shaft 1170. In yet another embodiment, the screw shaft 1170 may be located within the body member and the movable sections along the radial axis of the exhaust system, essentially passing through the middle of the device and allowing adjustment. In this embodiment, the stepper motor 1100 and controller 1000 can, for example, be located at one end of the exhaust system, as seen in FIG. 8B. In further exemplary embodiments, additional spring members, variations in the lengths of attachment member, the geometry of attachment members and similar variations may be used to facilitate variation in the relative motion of the divergent and convergent cone sections and other elements may be used to modify the adjustment function within the controller. It should also be noted, that again, the housing member 10 shown in FIG. 8 is not required.

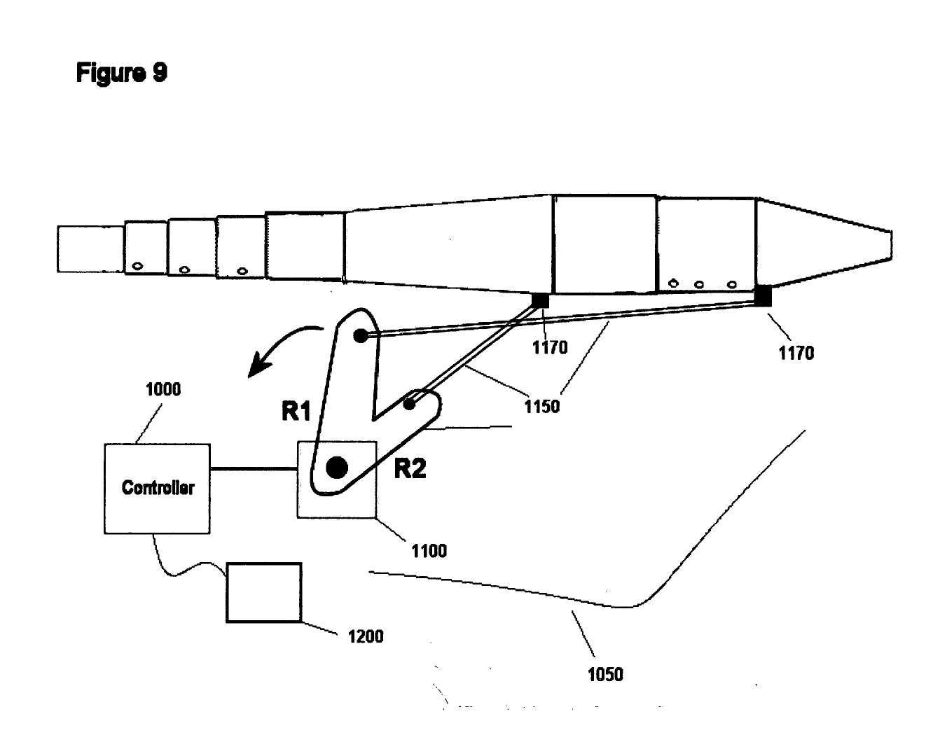

FIG. 9 shows still a further exemplary embodiment of the instant invention. In the exemplary embodiment of FIG. 9, the spring members are rendered unnecessary. The controller 1000 still receives information from an at least one sensor 1200. The controller controls an adjustment device 1050, which is also coupled to an actuator 1100. The adjustment device 1050 makes connections to a set of couplers 1170 on both the divergent slip sections 230,240,250,260 and convergent slip sections 330,340 and, thus, fully controls the adjustment of the sections. The relative movement of the sections can be calculated through the relative geometry of the attachment device 1150. The relative first radius R1 and the second radius R2 and the angle σ in the attachment device 1150 shown in FIG. 9 govern the movement of the slip sections, with variations in these variables causing differing linear motion in each section in a predictable fashion. Again, variations in the particular elements of the adjustment device 1050 can be made without departing from the spirit of the instant invention. In further exemplary embodiments, for instance, multiple attachment devices 1150 and/or multiple actuators 1100 may be included to provide the controller 1000 with the ability to independently control adjustment of the divergent and convergent sections through the adjustment device 1050.

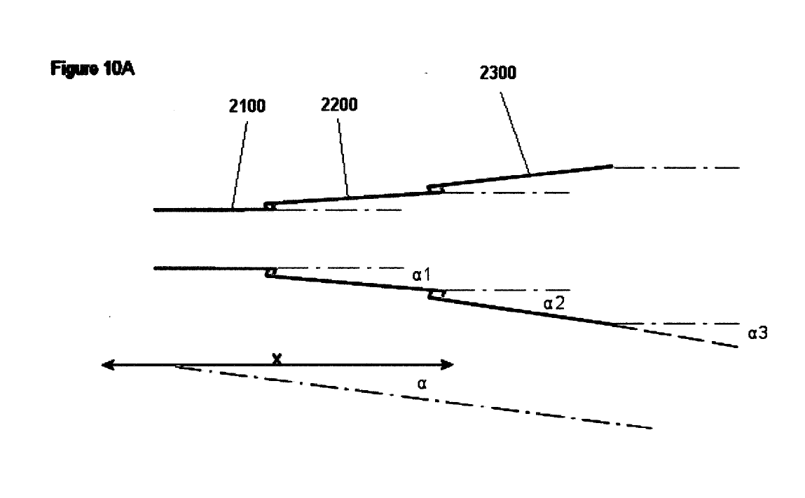

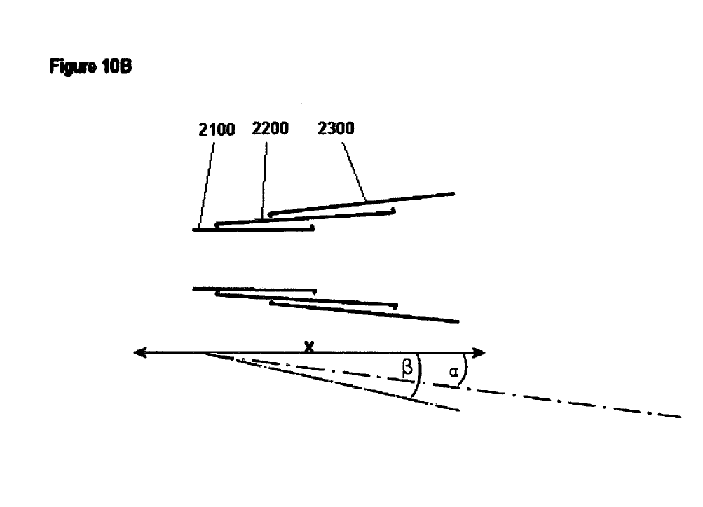

FIG. 10A shows a still further embodiment of the instant invention in an uncompressed state. The uncompressed at least one slip section comprises a series of three slip sections 2100, 2200, 2300. When extended the slip sections 2100, 2200, 2300 provide a long, narrow beginning expanding to a broader end for a divergent cone section 2300. This long narrow divergent cone geometry is very suitable for low RPM operations. This longer divergent cone section 2300 has an average expansion angle α through each of the slip sections 2100, 2200, 2300. Along each slip section, the inside angle increases throughout the divergent section and each slip section has a larger inside angle α than the last. These inside angles are labeled angle α1 for section 2000, angle α2 for section 2100 and angle α3 for section 2200. When fully expanded they provide for an average angle of expansion α.

FIG. 10B shows the embodiment of FIG. 10A in a compressed state with a sharper average angle of expansion. As the slip sections 2100, 2200, 2300 slidingly move from the uncompressed state shown in FIG. 10A to the compressed state shown in FIG. 10B, the average expansion angle presented moves from a (shown relative to the x-axis) to β as the point of contact between each respective slip section 2100, 2200, 2300, is moved further along the inside of the respective section. As this figure shows in comparison to FIG. 10A the average inside angle σ of expansion gets steeper as the point at which the slip sections meet is moved further along the and the inner profile of the respective slip section compress. A non-limiting example of an exemplary embodiment in a two stroke glow-ignition engine the extended system will have an effective profile of 12 mm to 24 mm in 86 mm or a relative expansion angle of 4 degrees (half angle or 6 mm/86 mm). The compressed state of the exemplary embodiment will function as a 12 mm to 24 mm in 50 mm or a relative expansion angle of 6.8 degrees. This higher average angle of expansion provides for performance increases at higher RPM operations. A similar procedure may be used to vary the inside angles of the convergent cones. The relative movement moving from a longer convergent cone section with a gradual angle of convergence to a sharper, more dramatic angle of convergence through compression of convergent slip sections. This variation can be done with or without the corresponding provisions for adjusting the tuned length.

Thus, in addition to providing a dynamic variation through compression of the tuned length of the system, the instant invention can also provide dynamic performance improvements by varying the geometry of the average angle of divergence or convergence through the articulated slip section portions. The system can thus further increase performance.

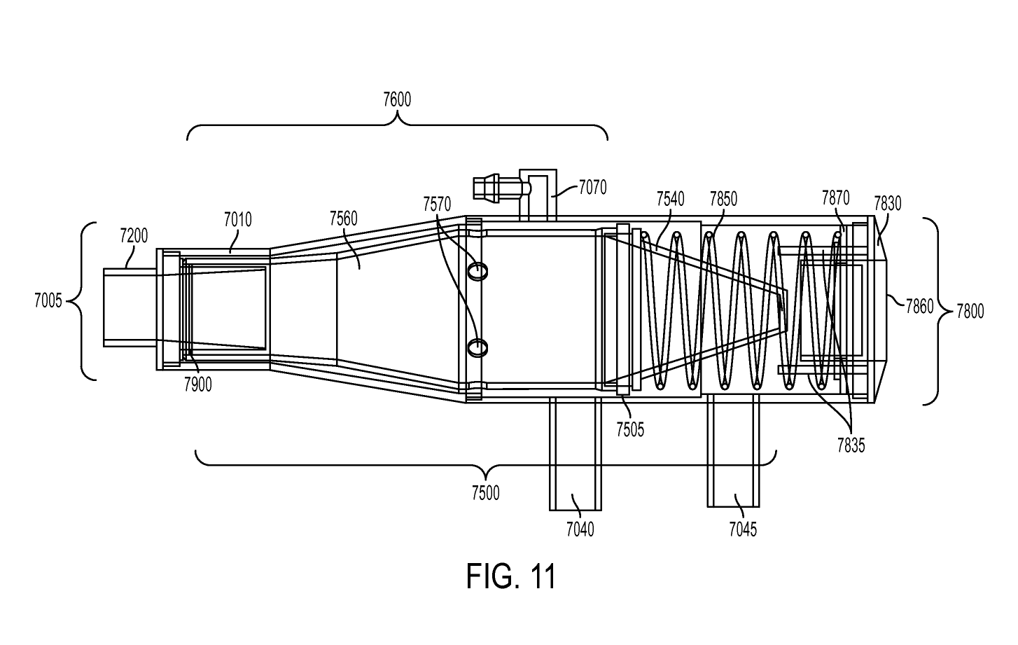

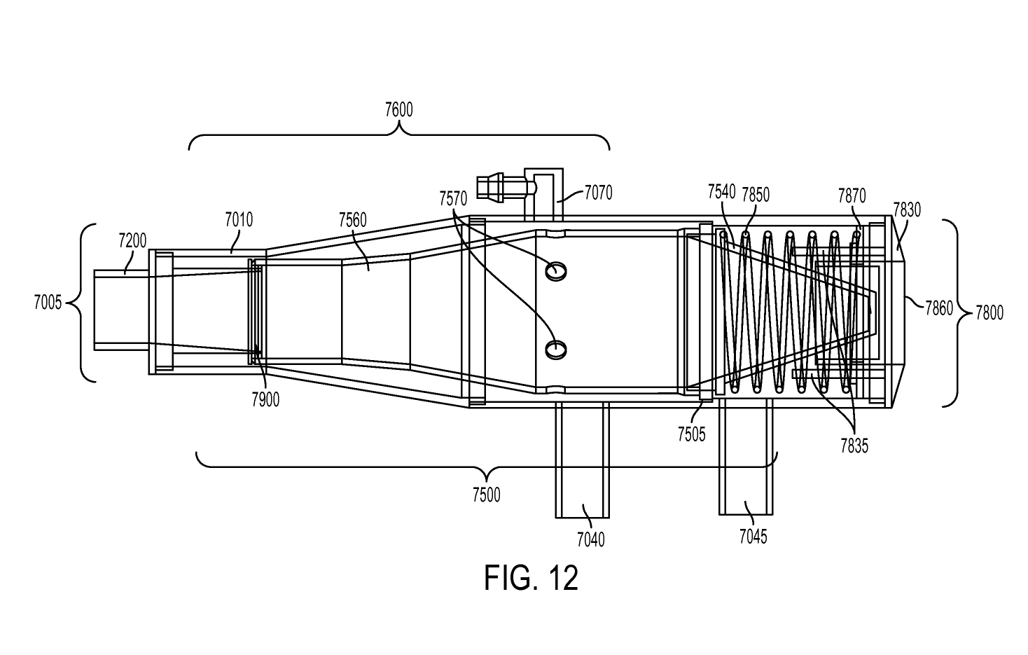

FIG. 11 shows a further embodiment of the instant invention and FIG. 12 shows the embodiment of FIG. 11 in a compressed state. The exemplary exhaust system of FIG. 11 comprises several separate pieces that are grouped into three subassemblies. The three subassemblies are joined, along with a spring, retaining clip and o-ring to complete the exemplary exhaust system. A body tube sub assembly 7005 is provided. This body tube subassembly 7005 includes a body tube 7010, open and threaded at both ends, formed from, for instance, aluminum or other suitable material. The body tube 7010, possesses two outlet pipes 7040, 7045 that are joined to the body tube by, for example, threading, brazing or any other suitable method. The body tube can also contain a pressure tap 7070 and a wire-mounting bracket (not pictured) as discussed in previous embodiments.

A slip coupling or header coupling 7200 is also provided. This component can be, but is not limited to, a machined brass fitting, hollow through the middle, and threaded to mate with the small end of the body tube 7010. The slip coupling 7200 couples the exhaust system to the header and exhaust of the motor, allowing for the exhaust gasses to flow through the system. The slip coupling also provides for lateral movement of the tuned subassembly 7500 along its length, as discussed further below. A further at least one slip fitting 7900 is provided. This component can take many diverse shapes, in the exemplary embodiment, for instance the slip fitting 7900 is shown as a hollow ring sized to snap fit into the small end of the divergent cone section 7560 and machined internally to fit over the external dimension of the slip coupling 7200. The at least one slip fitting 7900, in the exemplary embodiment, can be formed of a material which possesses both low thermal expansion and low friction qualities.

A tuned subassembly 7500 is also provided. The tuned subassembly 7500 includes a divergent cone section 7560. In the exemplary embodiment shown, this divergent cone section 7560 is shown as a hollow tube, open at both ends and threaded at the larger end. An at least one outlet hole 7670, here a plurality of outlet holes, are provided through the middle portion of the divergent cone section 7560. The location, number, shape and placement of the at least one outlet hole 7670 can be varied without departing from the spirit of the invention.

A convergent cone section 7540 is provided. The convergent cone section 7540 of the exemplary embodiment is provided as a hollow conical section, closed at the small end and open and threaded at the large end to mate with the divergent cone section 7560. A pressure ring 7505 is provided to fit between the body tube subassembly and the tuned subassembly 7500. In the exemplary embodiment, the pressure member 7505 is held between the assembled divergent cone section 7560 and convergent cone section 7540 and extends to the body tube 7010. In the exemplary embodiment, the pressure ring 7505 possesses an external dimension, which fits inside the internal dimension of the body tube subassembly 7005. The material properties of the pressure ring 7505 should be similar to the slip fitting.

An end cap subassembly 7800 is also provided comprising an end cap 7830. The end cap 7830 can be, for instance, a ring, hollow through the middle, and threaded on the external dimension to mate with the body tube 7010. In this exemplary embodiment, two pins 7835 are press fit into the side of the end cap 7830. The pins 7835 are, in an exemplary embodiment, smooth or polished on the exterior. Additionally, the hole through the middle of the exemplary end cap 7830 may posses any variety of grooves to accommodate a retaining clip or ring. An adjustment screw 7860 is provided. In the exemplary embodiment shown, the adjustment screw 7860 is cup shaped and threaded on the external dimension such that it does not contact the end cap 7830 during assembly. In the exemplary embodiment, the adjustment screw 7860 may possess various grooves on the external dimension where it does mate with the end cap 7830 to accommodate the aforementioned retaining clip or ring, as well as a groove to provide relief for an o-ring to seal between the end cap 7830 and the adjustment screw 7860. The adjustment screw 7860 in the exemplary embodiment also has a slot or hex recess in an external face to allow for turning by a screw driver or hex key.

One end of a spring member 7850 is seated in a spring seat 7870. The spring seat 7870 can comprise, for instance, a ring, threaded on the interior to mate with the external threads on the adjustment screw 7860. In the exemplary embodiment thus shown, the spring seat 7870 also possesses two holes, slightly larger than the pins 7835 pressed into the end cap 7830. Thus, when assembled the pins 7835 prevent the spring seat 7870 from rotating when the adjustment screw 7860 is turned providing for linear movement of the spring seat 7870 and the spring member 7850 in relation to the end cap 7830. Similar mechanisms may be provided for providing for lateral adjustment of the spring member 7850 relative to the end cap, as would be evident one of ordinary skill in the art, without departing from the spirit of the instant invention.

In operation, the exemplary embodiment of the dynamically tuned exhaust system of FIGS. 11 and 12, the system is attached at the slip fitting 7900 to the header of an appropriate motor (not shown) through a silicon coupling or any other appropriate method. The exhaust gasses will pass through the slip fitting 7900 into the interior of the tuned subassembly 7500. The gasses will then flow through the plurality of outlet holes 7670 drilled in the wall of the convergent cone section 7540 and into a pressure chamber 7600 formed by the external wall of the divergent cone section 7560 and the internal wall of the body tube subassembly 7005. The gasses will then flow through the outlet located closest to the slip coupling 7200, this outlet being the exhaust outlet tube 7040 in the exemplary embodiment.

As the operating pressure of the motor changes the force exerted on both the interior wall of the convergent cone section 7540 as well as the pressure ring 7505 will increase causing a compression of the spring member 7850 located between the spring seat 7870 and the external portion of the convergent cone section 7540. This will allow the tuned subassembly 7500 to move in a linear fashion thereby increasing the tuned length of the exhaust system. The second outlet tube or vent tube 7045 allows the air trapped between the convergent cone section 7540 and end cap subassembly 7800 to flow out and in as necessary. Additionally, any exhaust gasses or oils that blow through the pressure chamber 7600 and past the pressure ring 7505 can vent freely through the vent tube 7045. As the pressure drops spring member 7850 will push the tuned subassembly 7500 back to its original position. This internal motion can be adjusted to accommodate various engine pressures and operating conditions by adjusting the tension of the spring member by turning the adjustment screw 7860.

Initially the tuned length of the exhaust system is at its shortest position. This would seem to be counterintuitive, as it is well known that a greater tuned length improves low RPM operation. However, the unique characteristics of small displacement motors changes this characteristic somewhat. While it is important to have an appropriately long tuned length for low Rpm operation, in the small displacement motor, it is more important to reach the correct operating pressure quickly as the fuel system is augmented by a connection from the pressure tap to the fuel tank of the vehicle. In addition, an exhaust system would have to be prohibitively long for the hobby craft vehicle to improve the power output of these motors at less than about 15,000 RPM. The initial short tuned length also produces a comparatively small initial exhaust volume. This reduces the time necessary to reach a suitable operating pressure and improves throttle response in the exemplary exhaust system for dynamically changing tuned length.

Another characteristic of the small displacement hobby craft motors for which this exhaust system is designed is a naturally low torque peak compared to maximum RPM output. This produces high exhaust pressures at relatively low RPM levels. These high pressures cause the tuned subassembly 7500 to move to the maximum tuned length early on in the acceleration of the motor thereby improving the power output. As the RPM increases further, the torque and power levels begin to drop producing a corresponding drop in the exhaust pressure. This drop allows the tuned subassembly 7500 to gradually return to the shortest tuned length thereby benefiting the high RPM operation of the motor.

All of this is accomplished without varying the flow characteristics of the exhaust gasses in the exemplary embodiment of FIGS. 11 and 12. Meaning, the orifices regulating the flow of gasses through the exhaust system are not changed. The small initial volume of the exhaust system allows for relatively large orifices as compared to fixed exhausts without compromising throttle response, however these large orifices benefit high and very high RPM operation where a minimal restriction of exhaust flow additionally improves performance.

The embodiments and examples discussed herein are non-limiting examples. My invention is described in detail with respect to preferred embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. An apparatus comprising:
an at least one body element with a housing member having an at least one exhaust outlet;
an at least one exhaust element contained within the at least one body element with an at least one slip section and an at least one spring member; and
an at least one pressure regulating member extending and slidingly held between the at least one body element and the at least one exhaust element and separating a pressure chamber section within the housing, wherein the pressure regulating member is moved by the pressure in the pressure chamber section and in turn moves the at least one spring member resulting in a variation in the length of the exhaust system.

2. The apparatus of claim 1, wherein the at least one spring member initially biases the at least one slip section away from an end of the housing into which an exhaust gas pathway flows.

3. The apparatus of claim 1, wherein the at least one slip section is held at least partially within the at least one spring member.

4. The apparatus of claim 2, further comprising an at least one spring member stop mounted on the at least one slip section, the at least one spring member being urged against the at least one spring stop to move the at least one slip section.

5. The apparatus of claim 1, wherein the at least one single slip section is an at least one part of a header section.

6. The apparatus of claim 5, wherein the single slip section slides over a static exhaust system element.

7. The apparatus of claim 1, wherein the plurality of spring members comprises a first spring member and a second spring member.

8. The apparatus of claim 7, further comprising first and second spring member stops limiting the travel of the respective first and second spring members.

9. The apparatus of claim 1, wherein each of the at least one slip sections has a mechanical coupling element.

10. The apparatus of claim 9, wherein the mechanical coupling element further comprises a flanged portion and a flared portion that fit such that the flanged portion curves inwardly toward the slip sections and engages the flared sections limiting the travel of the sections relative to one another.

11. The apparatus of claim 10, wherein the mechanical coupling further comprises an at least one sealing member.

12. The apparatus of claim 1, wherein the at least one exhaust outlet is located in the outer housing along the concomitant wall of the pressure chamber section.

13. The apparatus of claim 1, wherein the at least one exhaust outlet is located at a point outside of the pressure chamber section along the concomitant wall of the remaining body section.

14. The apparatus of claim 1, wherein the at least one exhaust outlet is located in a main body portion of the housing member.

15. The apparatus of claim 1, wherein the at least one pressure regulating member further comprises an at least one exhaust channel through the at least one pressure regulating member.

16. The apparatus of claim 1, wherein the at least one slip section includes an at least one vent hole allowing escape of exhaust gases prior to the pressure chamber section.

17. The apparatus of claim 16, wherein the at least one vent hole is covered when the exhaust system changes length.

18. The apparatus of claim 1, wherein the body element further comprises a base cap and a header coupling at a first end of the body element coupling the apparatus to a pathway for spent exhaust gas and an end cap at an opposite end of the body member.

19. The apparatus of claim 1, further comprising a pressure tap.

20. The apparatus of claim 19, wherein the pressure tap further comprises a diverter element with a vent tube.

21. The apparatus of claim 20, wherein the diverter element is a conical shape.

22. The apparatus of claim 21, wherein the vent tube is coupled back to a motor fuel system.

23. The apparatus of claim 20, wherein the tube is coupled back to provide pressure to an injector in a fuel system.
